(19) United States
(12) Patent Application Publication
(10) Pub. No.: US 2005/0106280 A1
(43) Pub. Date: May 19, 2005

(54) Die apparatus for forming corrugated pipe

(76) Inventors: Gary L. Karr, Westerville, OH (US); David L. Cyphert, Canal Winchester, OH (US)

Correspondence Address: Gerald L.Smith;Mueller and Smith, LPA, 7700 Rivers Edge Drive, Columbus, OH, 43235, US

(21) Appl. No.: 10/715,760

(22) Filed: Nov. 18, 2003

(51) Int. Cl. B29C 47/20

(52) U.S. Cl. 425/325; 425/380

(57) ABSTRACT

Die apparatus configured for forming corrugated pipe from thermoplastic material in association with transported wall mold sets defining a wall forming tunnel. The apparatus employs two homogenizer stations, a first at its entrance for providing homogenized material to an outer wall delivery channel extending to an outer wall extrusion nozzle. Plastic material is delivered under pressure along a heated internally disposed extender pipe to a liner homogenizer stage located downstream and feeding a liner extrusion nozzle. An access region is made available between the outer wall extrusion nozzle and the liner extrusion nozzle.

### CROSS-REFERENCE TO RELATED APPLICATIONS

### STATEMENT REGARDING FEDERALLY SPONSORED RESEARCH

Not applicable.

### BACKGROUND OF THE INVENTION

Large diameter corrugated pipe employed for water runoff control, culverts and the like was introduced to the construction industry as a steel product. It's corrugate shape afforded good resistance against necessarily imposed compressive stresses, however, the undulatory pipe interior has not been one providing an efficient fluid flow characteristic. Over the somewhat recent past, as plastic technologies have advanced, opportunities for forming these structures from high density plastics arose.

The general approach to fabricating plastic corrugated pipe has been to extrude viscous thermoplastic material from a die assembly having an annular exit cross section. This extrudate is formed against the internal, corrugated surface of a continuing sequence of indexed mold sets. As the plastic extrudes through gauge defining extrusion die lip assemblies, it is drawn into the moving and now mated die sets, for instance, by an externally imposed vacuum. These mold sets, when united, define a dynamic forming tunnel moving along the production axis.

The plastics involved in this process, for example, high density polyethylene, are problematic in terms of their workability. In this regard, the material is introduced or cut at homogenization stations at the entrance of the extruding die with primary distributors in a plurality of streams. At this step in the process, the material has a somewhat putty-like consistency. These primary distribution streams discharge under high pressure into homogenization spiraling channels through which they progress in the form of a multiple thread. The depth of these helical channels progressively diminishes in the axial or extrusion direction. It is assumed that the stream progressing under pressure through one spiral divides itself into two partial streams. One of these divisional streams flows axially over a land formed between two spirals and the other follows the course of the spiral channel in a helical direction. Ultimately, the material flow is only in the axial direction and this resultant stream is formed by the superpositioning of the divisional streams. By this arrangement, a desired mechanical homogeneity of the now annular melt stream is achieved.

Control over the polymeric material as it progresses through the die both in terms of temperature maintenance and mass distribution has been problematic and a variety of control approaches have been advanced. One earlier such approach to maintaining product wall thickness or gauge consistency included, for example, the provision of adjustable annular extrusion die lips. Such “tweaking” at the gauge defining extrusion output now is being supplanted by modern computer modeling approaches. Temperature excursions within the extrusion system have resulted in a variety of anomalies in the resultant byproduct. For example, a lack of effective temperature control can result in a warped pipe product sometimes referred to as “banana pipe”.

Effective movement of the necessarily bulksom and heavy mold sets or blocks also has proven to be problematic. In the course of the continuous molding process, each mold set is parted from the moving and now molded pipe at a downstream release location, whereupon it must be returned to the molding commencement region of the die to be closed and abuttably indexed against the next axially forwardly adjacent closed mold set. The thus conjoined closed mold sets are axially driven in tandem at a rate controlled in consonance with the extrusion activity. Any vagaries encountered in this continuous process will result in any of a variety of product defects including pipe wall thickness deviations and corrugation pitch changes sometimes referred to as the “accordion effect”. Pitch variations will be manifested not only as an irregular wall surface, but also as a pipe length alteration. A variety of mold set transporting, parking, joining or closing and indexing schemes have been advanced, perhaps the more popular being a chain driven clamshell-like mold set wherein the molds are supported by pivotal mounts which ride, in turn upon continuous chains. With the arrangement, the mounts and molds are returned in an open orientation above the molding process, whereupon they are turned downwardly into alignment with the process axis and closed for indexing. This mechanically complex technique imposes a limitation on the number of mold sets which can be accommodated by the system.

Other mold set manipulation approaches have involved rack and pinion based systems wherein a rack component is associated with each mold which performs in conjunction with a gear drive; systems wherein each mold is driven by a discrete electric motor with associated electrical leads or umbilicals; and shuttle-based systems.

Originally produced plastic corrugated pipe exhibited an amount of undesirable flexibility. Such flexation attributes led to the implementation of internal liners which are co-extruded with the outer corrugated wall from annular extrusion nozzles located adjacent the outer wall extrusion annulus. As this inner liner or wall engages and attaches to the inwardly depending troughs of the outer wall, it moves axially along a cooling sleeve or mandrel.

Typically, homogenization of plastic including cutting for the inner liner is carried out at the same general rearward region of the die assembly as for the outer corrugated wall. This homogenized material then is maneuvered while being heated toward its extrusion annulus along an annular channel located in adjacency with the outwardly disposed heated channel carrying material for forming the corrugated outer wall. With this structuring, the outer channel is heatable from outwardly disposed surface heaters, while the inwardly disposed channel is heatable from those same outwardly disposed surface heaters. Remaining heat application to any one of these channels must be derived by conduction of heat from the adjacent channel. The plastics at hand generally exhibit low thermal conductivity, thus, such heating of plastic through a plastic is inherently thermally inefficient.

A particular difficulty is encountered with these outwardly disposed and adjacent material guiding channels in that there is no effective access to the downstream liner extrusion nozzle. Electrical access to heaters which advantageously might be attached to it is not sufficiently available. This tandem heating approach particularly becomes problematic where process start-up is called for following a process shut-down. During a shut-down state, plastics within the die will harden and must be re-melted and expelled from the system before commencement of production. Re-melting the material with the inefficient systems calls for quite high thermal inputs from outer wall surface heaters with attendant carbonization of the outer wall forming plastics and extended downtime. In the latter regard, restarting the process may require two or more days of production downtime.

### BRIEF SUMMARY OF THE INVENTION

The present invention is addressed to die apparatus employed with molding systems producing plastic corrugated pipe with transported outer wall mold sets. Thermoplastic material from one starting material extruder source is treated at a die entrance homogenizer stage which incorporates multi-stream cutting and discharges homogenized material under pressure into an outwardly disposed cylindrical distribution channel or reservoir. That reservoir extends to a downstream corrugated wall annular extrusion nozzle.

To form the liner attached to this corrugated wall, thermoplastic material from a second starting material extruder source is conveyed under pressure through the center of the entrance homogenizer stage, thence along an elongate extender tube or conduit located about the central axis of the die assembly to feed a second or liner homogenizer stage adjacent the corrugated wall extrusion nozzle. Homogenized plastic then is fed under pressure to an annular liner extrusion nozzle located downstream of the corrugated wall extrusion nozzle. With this arrangement, an access region is made available between the two extrusion nozzles permitting highly advantageous enhanced heater band based heating about the access region including the liner extrusion nozzle. By locating a sequence of heater bands or components along the centrally, internally located extender tube, highly enhanced heating capabilities are realized Heat is applied circumscriptively about this centrally located tube to achieve much more efficient thermal transfer between the heater components and the thermoplastic material within the tube. Because these heater components are disposed internally in a spaced relationship from the outwardly disposed cylindrical distribution channel or reservoir, confined radiative heating of its inward wall component is realized to be combined with the band heating assemblies at its outer wall. These extender tube coupled heater bands also are energized by multiple separate circuits such that substantial flexibility is made available for liner dedicated plastic heating. The arrangement additionally permits the formation of liners with plastic material having a different and unique formulation and/or colors. In effect, the die apparatus employs two separate thermoplastic heating systems to achieve more precise control over this critical parameter of the molding process.

That region of the die apparatus extending between the spaced-apart homogenizer stages represents a generally enclosed space immune from environmental air occasioned temperature excursions. The enclosed space, however, is accessible from both the die entrance and from the noted access region.

Uniform thermoplastic material expression from each of the two annular extrusion nozzles is achieved by the incorporation of annulus-shaped radially adjustable control rings located immediately upstream from each extrusion nozzle and having an annular edge region movable to adjust the cross section of an associated distribution channel. Concentricity adjustment between the die lips forming an extrusion nozzle also is made available with the apparatus.

Other objects of the invention will, in part, be obvious and will, in part, appear hereinafter.

The invention, accordingly, comprises the apparatus possessing the construction, combination of elements and arrangement of parts which are exemplified in the following detailed description.

For a fuller understanding of the nature and objects of the invention, reference should be made to the following detailed description taken in connection with the accompanying drawings.

### BRIEF DESCRIPTION OF THE DRAWINGS

FIG. 1 is a top partially schematic view of a corrugated pipe molding system employing the die apparatus of the invention;

FIG. 2 is a partial sectional view taken through the plane 2-2 shown in FIG. 1;

FIG. 3 is a sectional view taken through the plane 3-3 shown in FIG. 2;

FIG. 3A is an enlarged front end portion of the sectional view shown in FIG. 3;

FIG. 3B is an enlarged portion of the sectional view shown in FIG. 3;

FIG. 4 is a plan view of the entrance of the die apparatus shown in FIG. 3;

FIG. 5 is a sectional view of an entrance manifold shown in FIGS. 3, 3A and 4;

FIG. 6 is a downstream plan view of the manifold of FIG. 5;

FIG. 7 is a plan view of a homogenizer component shown in FIG. 3A;

FIG. 8 is a sectional view taken along the plane 8-8 shown in FIG. 7;

FIG. 9 is a plan view of a liner homogenizer shown in FIGS. 3 and 3B;

FIG. 10 is a sectional view taken through the plane 10-10 shown in FIG. 9;

FIG. 11 is a sectional view taken through the plane 11-11 shown in FIG. 3;

FIG. 12 is a sectional view taken through the plane 12-12 shown in FIG. 3;

FIG. 13 is a sectional view taken through the plane 13-13 shown in FIG. 3;

FIG. 14 is a sectional view taken through the plane 14-14 shown in FIG. 3;

FIG. 15 is a sectional view taken through the plane 15-15 shown in FIG. 3; and

FIG. 16 is a sectional view taken through the plane 16-16 shown in FIG. 3.

### DETAILED DESCRIPTION OF THE INVENTION

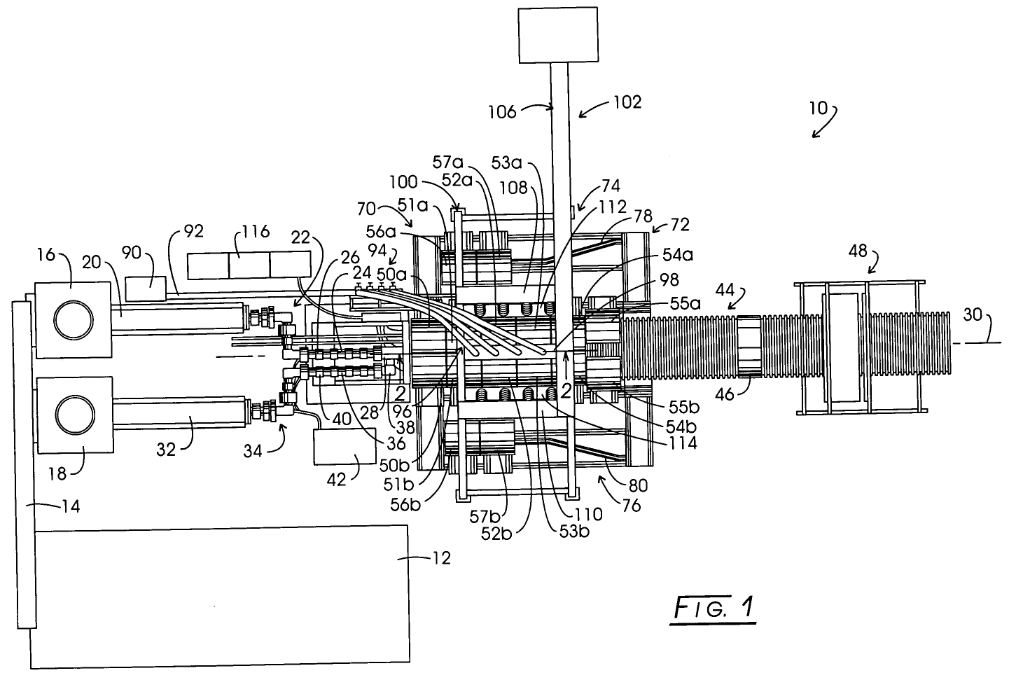

The apparatus of the invention performs in conjunction with moveable outer wall mold sets which are transported generally at a singular horizontal plane with a shuttle form of carriage and rail based system. Looking at FIG. 1, the system is represented generally at 10. Thermoplastic material is combined with, for example, carbon black at a mixing station represented schematically at block 12. While one source of material and formulation is indicated at block 12, it will be seen that the system 10 can perform with thermoplastic materials exhibiting different chemical formulations and/or colors. However, for the instant single material demonstration, the mixed thermoplastic materials are transported by a conveyer represented schematically at 14 to apportioning bins or hoppers 16 and 18. Bin 16 is dedicated to providing material for forming the outer corrugated wall of the produced pipe, while bin 18 apportions material for forming the inner liner of the pipe product. Bin 16 provides thermoplastic material to a heated extruder 20. From extruder 20 hot and melted thermoplastic material under substantial pressure is directed through a heated, dual elbow pipe configuration represented generally at 22, whereupon the material is directed through a somewhat elongate heated input pipe 24. Heating is provided by numerous electrically energized band heaters, one of which is represented at 26. Pipe 24 inserts melted heated thermoplastic material, for example at 400° F., into a manifold or block 28. Block 28 may be seen to be symmetrically disposed about the system axis 30.

In similar fashion, bin 18 provides thermoplastic material to a heated extruder 32 which expresses melted thermoplastic material under pressure through a dual elbow pipe configuration represented generally at 34 which, in turn, extends to an input pipe 36 which, in turn, delivers the heated material under pressure through an elbow connection 38 to a side surface located port of manifold 28. As before, a substantial number of band heaters are coupled with pipe 36, one of which is represented at 40. Control to these heaters is provided from a floor-mounted control console 42.

Molded corrugated pipe is represented generally at 44 being continuously extruded by the system 10 along axis 30. The pipe is shown having a bell component 46 and progresses continuously to a cut-off station represented generally at 48. Not seen is a lower disposed conveyer which supports pipe 44 as it progresses toward station 48. Station 48 is configured with rotary cut-off saws and is configured to move with the pipe 44 during the process of clamping on to it and carrying out sawing activity.

Eight paired mold sets 50a, 50b-57a, 57b are employed with system 10 and are transported by a rail or table and carriage-based system. In the figure, mold set 50a, 50b has been positioned by an entrance transport assembly represented generally at 70 to an entrance position whereupon the set will be pushed downstream along axis 30 into free abutment with mold set 51a, 51b. That mold set along with mold sets 52a, 52b and 53a, 53b constitute an axially moving forming tunnel. Mold set 54a, 54b is somewhat out of the forming tunnel and will commence to be parted in the manner shown at mold set 55a, 55b. As this mold set clears formed pipe 44 it is moved on a primary-secondary carriage system axially downstream in the sense of left to right in FIG. 1 by a puller conveyer system, whereupon the mold set halves are mutually transported transversely outwardly at an exit transport assembly represented generally at 72. Each mold half then is transported axially upstream by axial return transport assemblies as represented in general at 74 and 76. Assemblies 74 and 76 are seen to be configured with inwardly slanting cam rails shown respectively at 78 and 80. Cams 78 and 80 are engaged by cam followers (not shown) extending from the primary carriage associated with each mold set half. This arrangement provides for moving the mold set halves transversely inwardly on those carriage assemblies as represented at mold set halves 56a, 56b and 57a, 57b. In that position, the mold set halves are oriented for entrance into the forming tunnel.

Shown additionally in FIG. 1 is a vacuum pump function represented at block 90. The function 90 may be comprised of, for instance, four, twenty-five horsepower vacuum pumps. The vacuum output of function 90 is represented at line 92 extending to a vacuum manifold and valve assembly represented generally at 94 from which an array 96 of discrete vacuum lines extend to a four compartment vacuum manifold 98 supported upon a frame represented generally at 100. Frame 100 also supports an air blower assembly represented generally at 102 and comprised of an air blower function 104; an over and under duct assembly represented generally at 106 which supplies air to axially disposed air manifolds 108 and 110 from each of which flexible hoses depend downwardly to respective mold engaging air manifolds 112 and 114. Those manifolds 112 and 114 supply cooling air through the outwardly disposed surfaces of the mold sets as they are maneuvered while defining the forming tunnel of the system. Also shown in the figure is a floor-mounted control console 116.

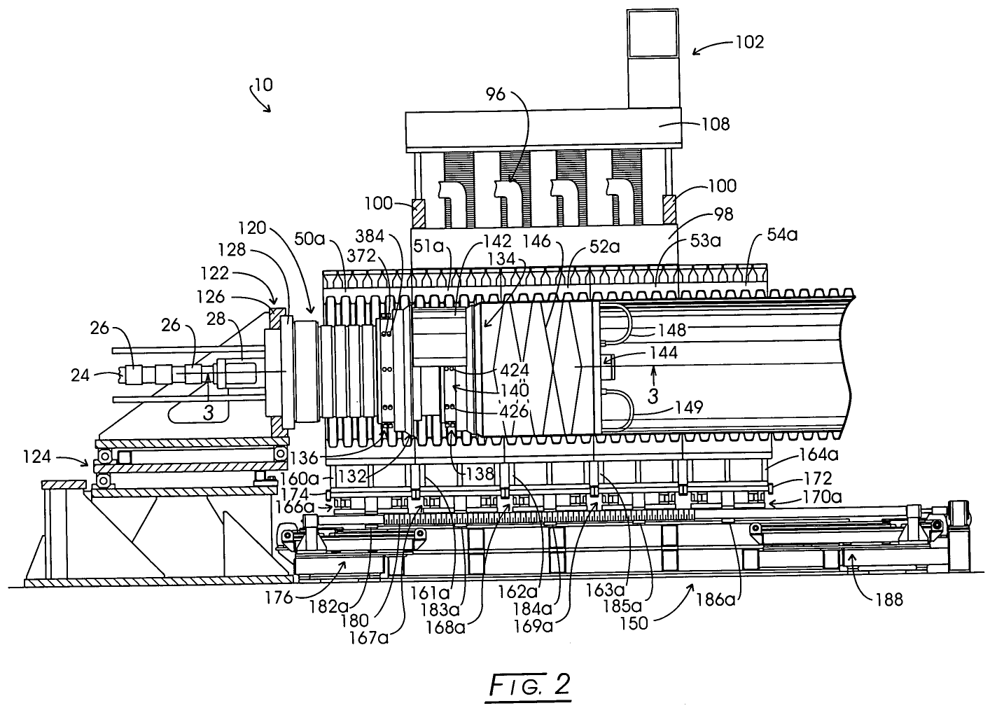

Referring to FIG. 2, the die assembly or apparatus of the invention is represented generally at 120. Assembly 120 is seen to be supported in cantilever fashion at die entrance 122 by a robust and adjustable die support assemblage represented generally at 124. In this regard, an upstanding flange assembly 126 of the support 124 is coupled to a die mounting ring 128 which, inter alia, supports a heater band enveloped outer wall surface extending to an annular outer wall forming extrusion nozzle represented generally at 132. Located axially forwardly of the outer wall nozzle 132 is an inner wall forming extrusion nozzle represented generally at 134. Material flow and die lip concentricity adjustment assemblages as represented generally at 136 and 138 are located immediately upstream of the respective nozzles 132 and 134. It may be noted that an annular access region represented generally at 140 is present between the extrusion nozzles 132 and 134. The upper one half of region 140 is protected by a semi-cylindrical shield 142. Attached to the die adjacent inner wall extrusion nozzle 134 is a cylindrical cooling sleeve represented generally at 144 incorporating spiral vacuum notches 146. Water circulation inlet and outlet hoses are identified respectively at 148 and 149.

The main frame of the mold set transportation assemblage is represented in the figure in general at 150. Mold sets 50a, 50b-57a, 57b are supported upon this main frame 150 in conjunction with an assemblage of transport carriages and support stands. In the latter regard, note that mold components 50a-54a are affixed to respective mold support stands 160a-164a. Stands 160a-164a, in turn, are mounted upon respective primary carriages represented generally at 166a-170a. Carriages 166a-170a are configured with forwardly and rearwardly disposed bumpers which are engageable from mold set to mold set in freely abuttable fashion. One such bumper is shown at 172 in connection with primary carriage 170a, while a rearwardly disposed bumper is shown at 174 in connection with carriage 166a.

The forming tunnel generally is considered to extend the axial length of vacuum manifold 98 as the carriages are maneuvered toward the tunnel, downwardly depending nut components or threaded nut halves will be positioned to engage and be driven somewhat in cam fashion by a continuously rotating endless screw or translation component 180. In this regard half nut followers 182a-186a are seen extending from respective primary carriages 166a-169a. Note that follower 182a has not engaged the threaded region 180 and that half nut follower 186a has moved off the threaded region and is about to be moved to the exit transport assembly 72 (FIG. 1) by a puller conveyer represented generally at 188.

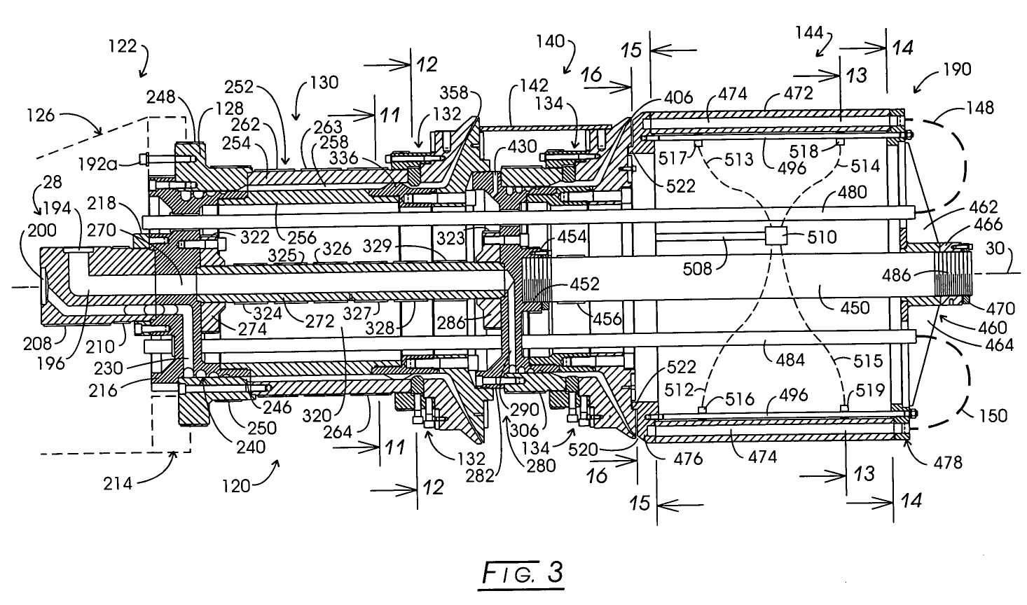

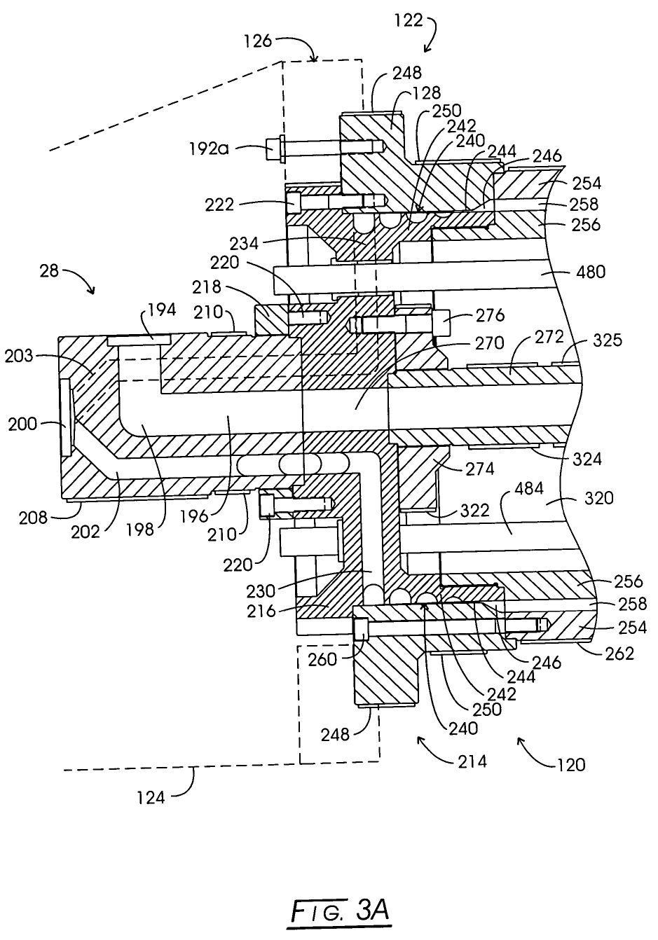

Referring to FIG. 3, the die assembly or apparatus 120 is revealed in section as it extends in cantilever fashion from the earlier-noted die entrance 122 to its die exit represented generally at 190. Die mounting ring 128 reappears and is shown connected to upstanding flange assembly 126 by a sequence of annularly disposed bolts or machine screws one of which is revealed in FIGS. 3 and 3A at 192a. Looking additionally to FIG. 4, the remainder of these machine screws extending to the mounting ring 128 are revealed at 192b-192p. These figures further reveal input manifold or block 28 as having a side input port which is connectible with earlier-described elbow 38 (FIG. 1) and receives hot thermoplastic material under pressure from input pipe 36. Port 194 communicates with a material flow path 196 which incorporates an elbow region 198. Manifold 28 additionally is configured with a second input port 200. Port 200 is connectable in material flow communication with input pipe 24 (FIG. 1) and is configured to provide a preliminary four-way cut of that material. In this regard, as seen in FIGS. 3A and 4-6, four, radially outwardly disposed highly polished paths 202-205 are established. This preliminary cutting of material serves to avoid interference with pathway 196. FIGS. 4-6 further show that the manifold 28 is configured with threaded bores functioning for connection with input pipes. Certain of these threaded bores are identified at 206 in the latter figures. FIG. 3A reveals that the block 28 is heated by electric heaters as identified at 208 and 210.

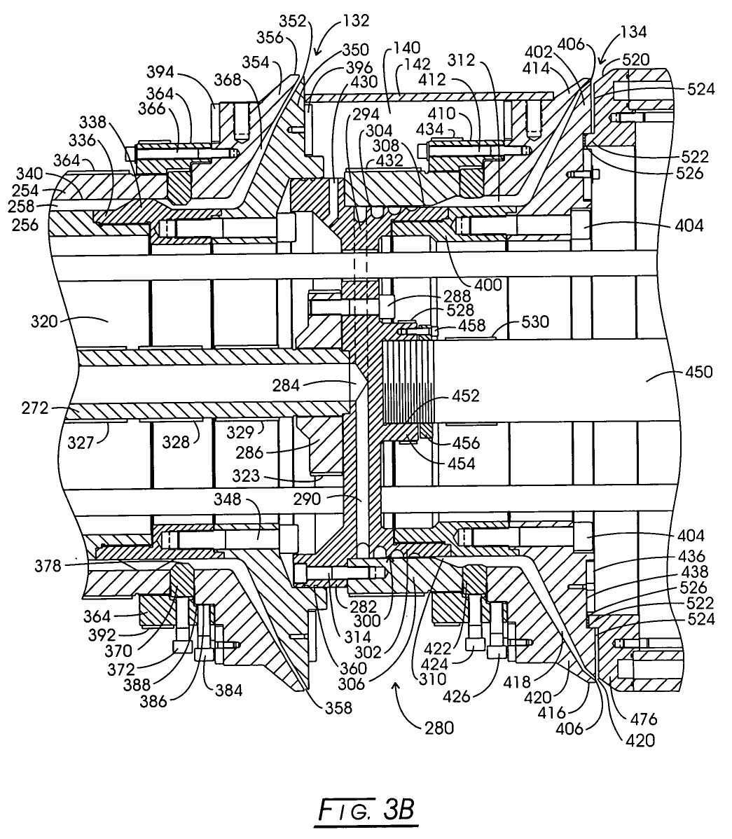

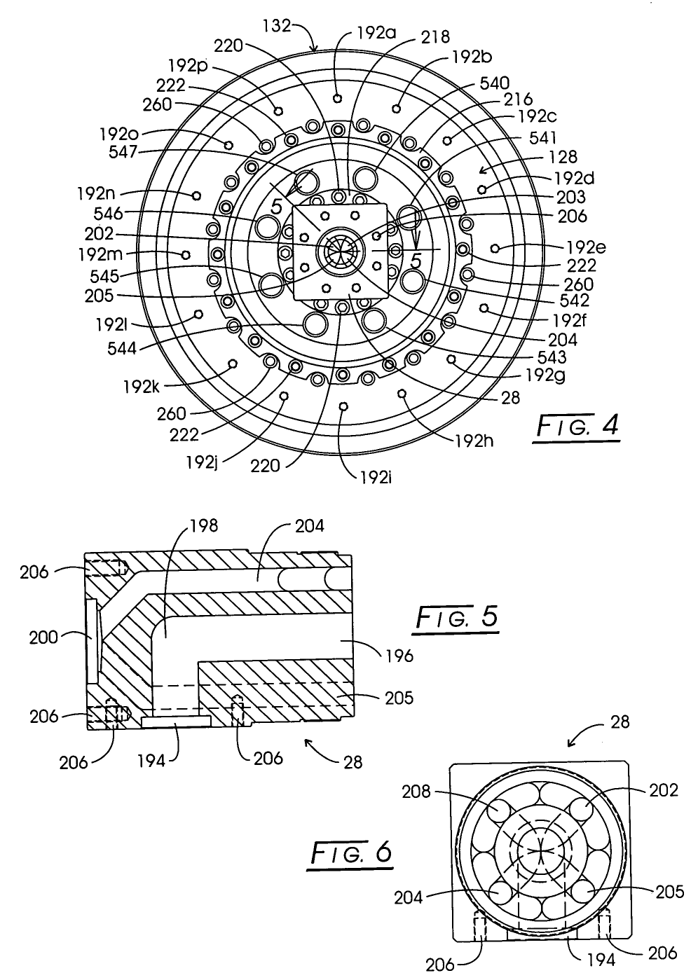

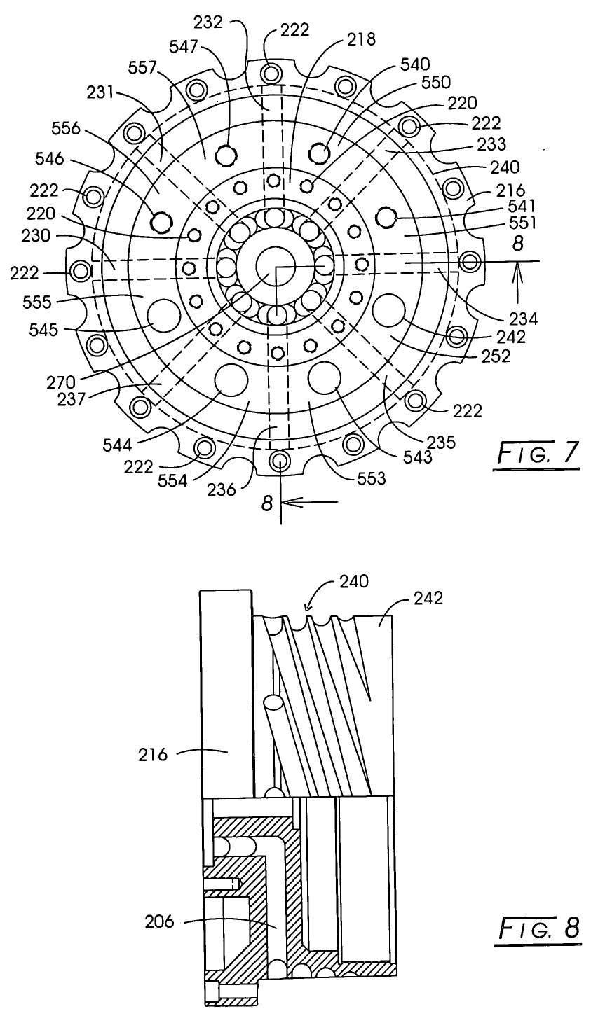

Returning to FIGS. 3 and 3A, manifold 28 is seen to be coupled with a component of an outer wall forming assembly represented generally at 214 and located at the die entrance 122. Assembly 214 receives thermoplastic material under pressure from the paths 200-203; cuts it into eight separate radially directed and symmetrically disposed streams which extend in turn to discharge into spiraling channels machined into a mandrill. This entire assemblage is referred to herein as an “homogenizer assembly”. Assembly 214 is configured with a homogenizer component 216 to which the output side of manifold 28 (FIG. 6) the center of which is coupled with an annular collar 218. Connection is with machine screws or bolts certain of which are identified at 220 in FIGS. 3A and 4. FIGS. 3A and 4 reveal that component 216 is connected to die mounting ring 128 by a plurality of machine screws or bolts certain of which are identified at 222. Looking additionally to FIGS. 7 and 8 the internal structuring of homogenizer component 216 is revealed. In the figure, heated thermoplastic material under pressure is introduced from the four pathways 202-205 (FIG. 6) whereupon the material is cut into eight bore-defined streams within symmetrically radially disposed highly polished paths seen in FIG. 7 at 230-237. Each of the four manifold incorporated paths 202-205 feeds two of the radially disposed paths 230-237. As seen in FIGS. 3A and 8, the molten material within paths 230-237 is discharged into four spiraling channels represented generally at 240 which are machined into a mandrill portion 242 of homogenizer component 216. As seen in FIGS. 3A and 8 the depth of these channels decreases steadily. FIG. 3A reveals that mandrill portion 242 as well as the groove 240 are located in adjacency with the inner annular wall 244 of die mounting ring 128. The gap between these spiraling channels and that inner wall 244 increases steadily in the direction of extrusion. With this arrangement, it is generally assumed that the stream flowing through one spiral divides itself into two partial streams. One of them flows axially over a land formed between two spirals and the other follows the course of the spiral channel in the helical direction until finally, the exit melt flow is only in the axial direction. The homogenizer exit is shown at 246 in FIG. 3A. Heat is applied to this homogenization process from electrical heating components or bands as at 248 and 250 which are coupled in thermal exchange relationship with mounting ring 128, the inner wall of 244 of which functions as a die-homogenization component. Component 128 additionally supports components defining an annular delivery chamber represented generally at 252. Sometimes referred to as a reservoir, the chamber 252 is configured with an outer cylinder 254 and an inner cylinder 256 to define an annular pathway 258. Pathway 258 is seen to be in material transfer relationship with the outer wall homogenizer exit 246 (FIG. 3A) and extends to fluid material transfer communication with outer wall extrusion nozzle 132. FIGS. 3A and 4 reveal that the outer cylinder 254 is connected to die mounting ring 128 by machine screws or bolts certain of which are revealed at 260. Note that the material within the annular pathway 258 is heated by outboard band heaters 262-264.

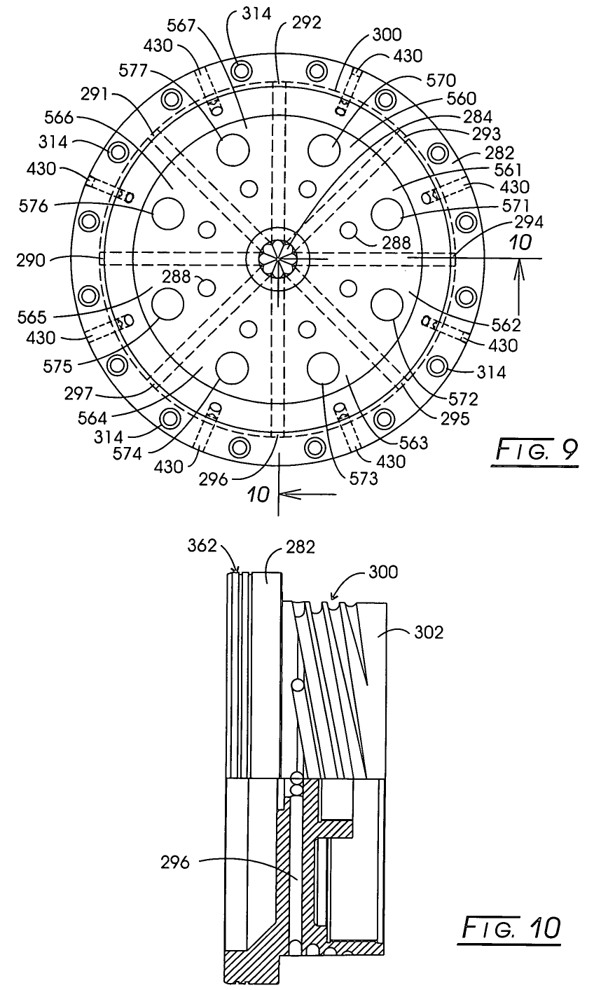

Returning to the die entrance 122 and FIGS. 3, 3A and 7, path 196 extending from manifold port 194 is seen to communicate with a cylindrical opening 270 extending through homogenizer component 216. Opening 270, in turn, is coupled in material transfer relationship with an extender conduit or tube 272. Tube 272 is fixed to the downstream side of homogenizer component 216 by a collar 274, the connection being made with machine screws or bolts as at 276. Tube 272 extends axially within cylinder 256 to an inner wall forming treatment assembly identified generally in FIGS. 3 and 3B at 280. Assembly 280 is configured with a homogenizer component 282. Looking additionally to FIGS. 9 and 10, the component 282 is seen to have a centrally disposed intake port 284 which is in material transfer communication with extender tube 272. In this regard, the extender conduit 272 is coupled to homogenizer component 282 with a collar 286 secured by machine screws certain of which are identified at 288. FIG. 9 reveals that homogenizer component 282 functions to cut the incoming thermoplastic material into eight highly polished distribution bores or paths. As in the case of homogenizer component 216, the pathways 290-297 discharge into four spiraling channels represented generally at 300 in FIGS. 3B and 10. Channels 300 are machined into the mandrill portion 302 of homogenizer component 282. As before, the spiraling channels 300 decrease in depth steadily and are located in adjacency with the inward surface 304 (FIG. 3B) of a die ring 306 to define a gradually widening gap 308 which extends to an inner wall homogenizer exit 310. Die ring 306 additionally forms a portion of a forshortened cylindrically-shaped delivery chamber 312 which is in material transfer communication with inner wall extrusion nozzle 134. Die ring 306 is retained in position by machine screws or bolts certain of which are identified at 314 in FIGS. 3B and 9.

FIGS. 3, 3A and 3B reveal that homogenizer components 216 and 282 along with inner cylinder 256 define a generally enclosed space 320. While material intended to form the outer corrugated wall of the pipe 44 are principally heated by a heater assembly comprised, inter alia, of outboard heaters 248, 250 and 262-264, the inner wall or liner dedicated thermoplastic material is heated by a heating assembly which includes a plurality of band-type heater components surmounting the outer surface of extender tube 272 within the enclosed space 320. For instance, heater component or band 322 surmounts collar 274 and heater component or band 323 surmounts collar 286. Over the outer surface of extender tube 272 there are positioned six heater components or bands 324-329. Thus, there are eight heater components within the enclosed space 320 providing heat input to the material within extender tube 272 for a somewhat lengthy and advantageous dwell interval. Because such heater components are not available at the surface of inner cylinder 256 defining delivery chamber or reservoir 258, the enclosed space 320 advantageously locks out any cooling ambient air and the heater assembly within it provides radiative heating of inner cylinder 256. The heater component assembly within the enclosed space 320 is configured with, for instance, three separate electrical circuits which are connected to, for example, three spaced apart heater components. Thus, a redundancy assures the availability of heat input to the extended conduit 272 even though one set of the heater components may fail. Additionally, the amount of thermal energy supplied from the heater assembly within space 320 may be adjusted utilizing these discrete circuits.

Returning to FIGS. 3 and 3B, the outer wall material delivery channel 258 is seen to be configured such that the inner wall component or cylinder 256 thereof is configured with a ring-shaped wall support member 336. Looking additionally to FIG. 11 support 336 is fixed to the inner wall or cylinder 256 defining delivery channel 258 and is formed with spaced apart stand-off components certain of which are identified at 338 which extend to freely abut and support the inner surface 340 of outer cylinder or wall 254. FIG. 11 reveals that these stand-off components 338 may, in effect, cut the plastic material flow into a multitude of material streams. Attached to support member 336 by machine screws or bolts as at 348 is an outer wall downstream die lip 350 which extends to downstream lip edge 352. Die lip 350 cooperates with an upstream die lip 354 which forms a portion of the delivery channel 258 and extends to a lip edge 356. The spacing between lip edge 352 and lip edge 356 defines an annular lip opening 358 through which molten thermoplastic material may be expressed toward the moving vacuum-based mold sets to form the corrugated outer wall of pipe 44 (FIG. 1). An inward annular surface 360 of die lip 350 engages paired gaskets (not shown) within paired grooves represented generally at 362 (FIG. 10) in an upstream extension of homogenizer component 282.

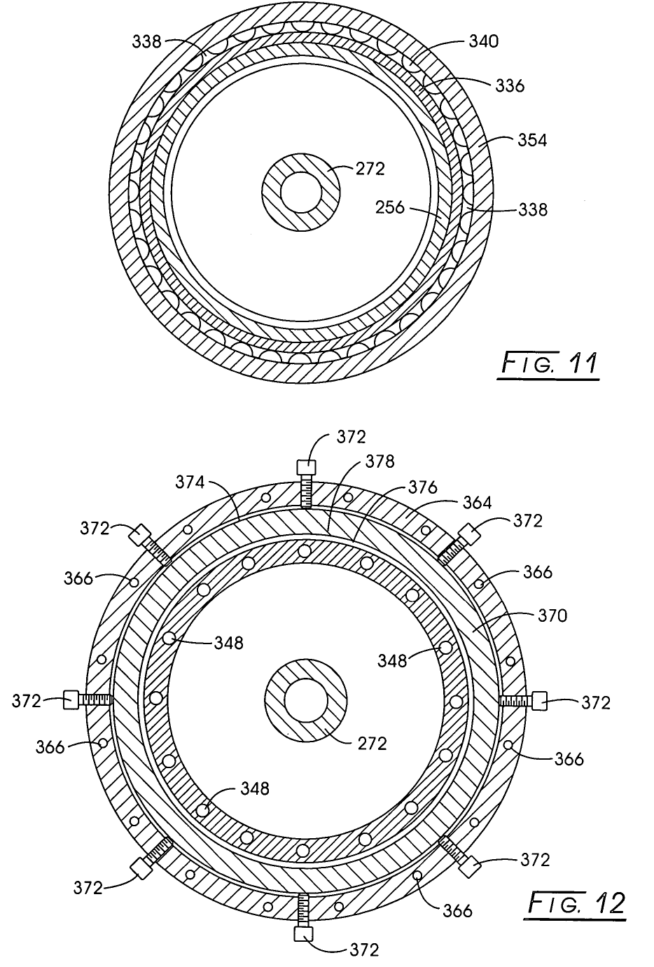

Looking additionally to FIG. 12, die lip 354 is seen to be retained in position by a ring-shaped support member 364 and machine screws or bolts certain of which are identified at 366. Delivery channel 258, as it extends to the vicinity of support member 336 will exhibit a channel annular cross section through which melted thermoplastic material is driven under pressure. As the plastic material approaches the extrusion nozzle channel 368 its distribution within the channel may be adjusted to achieve more uniformity by manipulation of a control ring 370. Ring 370 is mounted normally to axis 30 and may be adjusted up and down and from side to side by a plurality of radially disposed screw members certain of which are revealed at 372 extending through and threadably engaged with support member 364. FIG. 12 reveals eight such adjustment screws 372 extending through support 364 in a manner wherein their radially inwardly disposed tips are in freely abutting contact with the radially disposed annular surface 374 of control ring 370. Manipulation of these screw members 372 will alter the channel annular cross section 376 where called for. In this regard, the radially disposed annular edge region 378 is extensible within the channel annular cross section 376 to provide the noted material flow uniformity. To accommodate for the above-noted cutting effect which is developed by the stand-offs 338 of support 336, the inner diameter of control ring 370 is selected such that edge region 378 extends for enough radially inwardly to establish a material flow back pressure effective to merge any material streams which may have developed.

Annular lip opening 358 also can be adjusted for concentricity by manipulation of an array of machine screws, one such machine screw being shown at 384 in FIG. 3B. Screws as at 384 are threadably engaged within support ring 364 and their radially inwardly disposed tips as at 386 freely abuttably engage annular ledge 388 of die lip 354. To make this concentricity adjustment with the concentricity adjustment machine screws as at 372, machine screws as at 366 are loosened. A band-type heater component 392 is shown in thermal transfer relationship with support ring 364 and additional heater components as at 394 are coupled in thermal exchange relationship with upstream die lip 354. Similarly, a heater component 396 is coupled to downstream die lip 350.

Now looking to the configuration of components associated with liner delivery channel 312 and liner extrusion nozzle 134, FIG. 3B reveals a cylindrical inner wall component 400 which extends from mandrel portion 302 of homogenizer component 282. A liner or downstream die lip 402 is bolted to inner wall component 400 with an array of machine screws or bolts, two of which are shown at 404. Die lip 402 extends to a lip edge 406.

A liner ring-shaped support member 410 incorporates an array of axially disposed machine screws or bolts 412 which function in the manner of machine screws 366 to support upstream liner die lip 414. Die lip 414 extends to a lip edge 416 and defines a liner nozzle channel 418 extending to an annular lip opening 420. Radially space from and located below support ring or member 410 is a liner control ring 422 which is configured in the manner of control ring 370. In similar fashion, the control ring 422 may be adjusted in an up/down and side-to-side manner to alter the delivery channel 312 cross section in a manner providing for a uniform discharge of thermoplastic material into the nozzle channel 418. An array of liner control ring adjustment screws, one of which is shown at 424 may be manipulated in the same manner as adjustment screws 372 to achieve uniform material flow.

Liner support ring or member 410 also incorporates an array of radially disposed concentricity adjustment screws, one of which is revealed at 426 which perform in the same manner as concentricity adjustment screws 384. As before, machine screws as at 412 are loosened before this concentricity adjustment is made wherein the annular lip opening 420 is made uniform.

Of particularly beneficial aspect of the instant die apparatus stems from the downstream location of homogenizer 282 as it performs in conjunction with extension tube 272. This permits the development of the earlier-described generally annularly-shaped access region 140 between the extrusion nozzles 132 and 134. FIGS. 3B and 9 reveal that region 140 is accessible from region 320 through an array of radially disposed access ports 430. With this arrangement, electrical circuitry can be maneuvered through certain of the ports 430 to energize band-type heater components as at 432 coupled in thermal exchange relationship with die ring 306 as well as at 434 in thermal exchange relationship with support ring or member 410. Where the liner homogenizer is located at the entrance to the die assembly, such heating components are not electrically accessible. Note that a heating component 436 is coupled to the downstream annulus-shaped surface 438 of downstream die lip 402. Electrical leads also may extend to a pressure sensor within region 140 to provide make-up air monitoring and control. Thermistors associated with heater components within region 140 also may electrically access through ports as at 430.

Maintenance of proper elevated temperatures in the vicinity of the inner liner extruder nozzle 134 is quite important inasmuch as the next component of the die assembly 120 is a relatively large cylindrical cooling sleeve shown in general at 144 in FIGS. 2 and 3. FIGS. 3 and 3B reveal that the sleeve 144 is principally supported by a relatively large support tube 450 which extends from a threaded connection 452 with a boss-like projection 454 integrally formed with liner homogenizer 282 at its downstream face. This connection is enhanced with a collar 456 coupled to boss 454 with an array of machine screws, one of which is revealed at 458. Support tube 450 extends to the die exit 190 whereat it extends through an open webbed spider support represented generally at 460, two of the webs of which are shown at 462 and 464. The spider is retained in position by a large nut 466 threadably engaged with threaded region 486. A jamb nut 470 assures securement of nut 466.

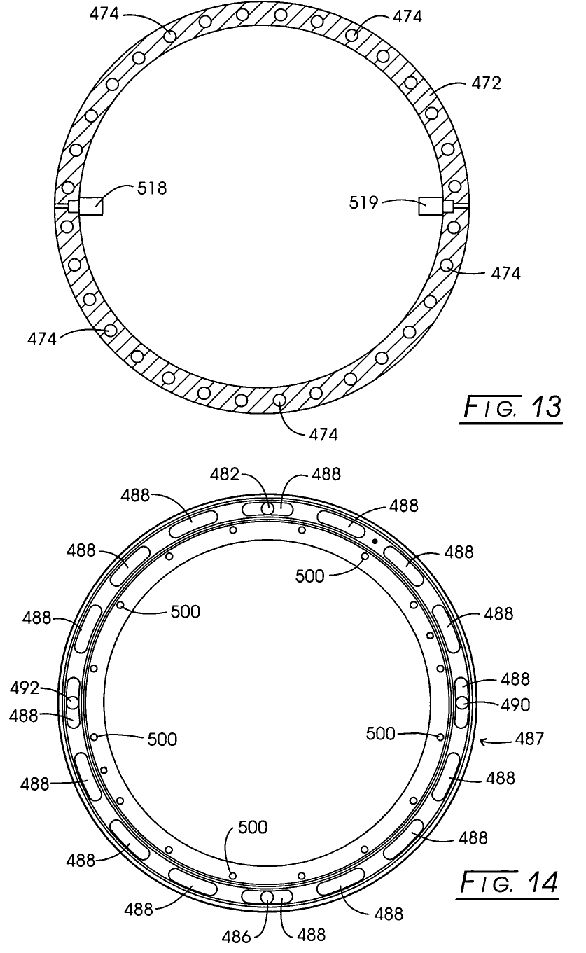

Looking additionally to FIG. 13, manifold 472 is configured with a plurality of elongate conduits certain of which are identified at 474 which extend between an annular-shaped upstream endcap 476 and an annularly-shaped downstream endcap represented generally at 478. Looking additionally to FIG. 14, cooling water is supplied via elongate conduit 480 from the die entrance 122 to the die exit 190, whereupon it is delivered by hose 148 to port 482 in endcap 478. In similar fashion, cooling water is returned via elongate conduit 484. In this regard, looking again additionally to FIG. 14, hose 150 functions to convey return water from port 486 , such conveyance extending from die exit 190 to die exit 122. Endcap 478 is configured having an annularly disposed array of oval-shaped pockets, each of which is aligned with two of the conduits 474 described in connection with FIG. 1 3. Ports 490 and 492 shown in FIG. 14 are plugged and not used.

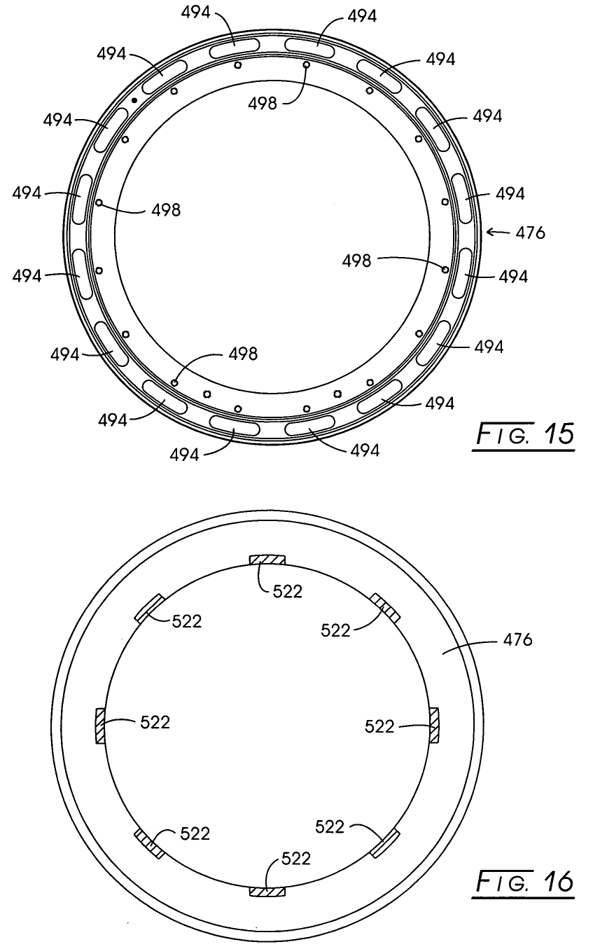

Looking to FIG. 15, the upstream endcap 476 is seen to be configured in the same manner with a sequence of oval-shaped pockets 494. As in the case of pockets 488, each of the pockets 494 is aligned with two of the conduits 474 of the manifold 472. With the arrangement shown, as seen in FIG. 14 where cooling water enters port 482 from hose 148 it flows under pressure towards a corresponding offset pocket 494 such that the water courses back and forth from conduit to conduit down each side of the manifold 472, whereupon it exits at port 486 to enter hose 150 and return via conduit 484. An array of elongate tensioning rods, two of which are shown in FIG. 3 are identified at 496. Rods 496 are engaged with threaded bores within endcap 476, certain of which are identified at 498 in FIG. 15 and extend downstream to extend through bores in endcap 478 for exterior bolted connection. Certain of the bores within endcap 478 are represented at 500 in FIG. 14.

As discussed in connection with FIG. 2, the outer surface of cooling sleeve 144 is configured with spirally disposed vacuum notches identified in that figure at 146. It may be noted in that figure, that these notches particularly are spaced away from endcap 476 by a distance of about 6 inches. Returning to FIG. 3, a vacuum conduit 508 is seen extending to the interior of cooling sleeve 144 to terminate in a vacuum manifold 510. The conduit 508 extends through the die assembly to the die entrance 122. However, that extension is not shown in the interest of clarity. From the manifold 510 vacuum lines 512-515 extend to respective vacuum fittings 516-519 which communicate with the grooves 146. Couplers 518 and 519 additionally are seen in FIG. 13.

While the control of heat introduction into the thermoplastic material being extruded is quite important, it has a significant importance at the region of the interface between inner liner extruder nozzle 134 and cooling sleeve 144. In general, the cooling sleeve 144 will be operated at a cooling temperature of from about 60° F. to about 150° F. By contrast, extrudate from the liner nozzle 134 may be, for instance, at a temperature of about 400° F. Accordingly, the interface between extruder nozzle 134 and the aluminum cooling sleeve 144 becomes an important design consideration. For example, some operators at the start-up of a system will run the cooling sleeve as warm as possible. Conversely, causing it to become too hot will cause the plastic to commence to stick and the corrugations of the outer wall will commence to drag on the inner liner passing across the cooling sleeve. In normal operation, cooling commences at about the point or annular location 520 shown in FIGS. 3 and 3B. To minimize the extent of the interface between cooling sleeve 144 and the inner liner extrusion nozzle 134 endcap 476 is structured so as to have minimal freely abutting surface contact with the downstream facing annular surface 438 of die lip 402. Note in the figures that the upstream face of endcap 476 is configured with arcuate tabs, certain of which are revealed at 522 having an axial thickness of about ¾ inch and an arcuate length of about 3 to 4 inches. These tabs space the annular upstream surface 524 of endcap 476 away from the adjacent surface of die lip 402. The upstream face of each of the tabs 522 further is covered with a thermal insulator material seen in FIG. 3B at 526. Looking momentarily at FIG. 16, endcap 476 is revealed in conjunction with eight symmetrically disposed tabs 522 arranged in 45° radial increments. Insulators 526 may be provided as a ceramic fiber strip having a thickness of about 1/16 inch. Such material is marketed, for instance, by McMaster-Carr Supply company of Aurora, Ohio.

To further assure adequate heat development at the components developing the inner wall or liner, heater components or bands are disposed in the vicinity of support pipe 450. For example, as seen in FIG. 3B a heater component or band 528 surmounts projection 454 and another heater band or component 530 is positioned about support tube 450 in the vicinity of its upstream end.

Returning to FIGS. 3 and 3B, as thermoplastic is extruded from the outer wall extruder nozzle 132, it impinges upon the inwardly depending valleys of the corrugate internal structure of the mold sets, whereupon it is drawn to the external peaks by vacuum applied to the molds. This arrangement proceeds across the access space 140, whereupon the inner liner is extruded from extrusion nozzle 134 to, in effect, weld to the inwardly depending valleys of the outer wall corrugated structure. Without more, this would tend to create a vacuum within region 140. Accordingly, make-up air at relatively low pressure, for example, 10 psi is applied within that region during operation of system 10. The make-up air may be inserted through one or more of the earlier-described access ports 430 In general, a thermocouple will be incorporated with any of the heater components in the system.

Axially spaced apart positioning of homogenizer components 216 and 282 provides the advantage of providing interface access to all internal regions of die assembly 120. In this regard, elongate conduits as earlier-described at 480, 484 and 508 may be employed for access between the die entrance 122 and die exit 190. Returning to FIG. 4, the conduit supporting access ports at the die assembly entrance are represented at 540-547. These ports reappear in FIG. 7 in conjunction with the earlier-described positioning of the radially disposed bores or paths 230-237 of the homogenizer cutting function. The 45° incremental orientation of these paths permit the definition of outer wall communication regions 550-557 through which the respective ports 540-547 extend.

Referring again to FIG. 9, inner wall homogenizer component 282 similarly is configured with inner wall communication regions 560-567 located between the distribution paths 290-297. Because these distribution paths are aligned with respective distribution paths 230-237 of homogenizer 216, outer wall communication regions 550-557 are respectively axially aligned with inner wall communication regions 560-567. With this arrangement, conduit supporting apertures or openings 570-577 are axially aligned with respective ports 540-547 of outer wall homogenizer component 216. Functions employed for these conduits include but are not limited to the earlier-described replacement air; the cooling sleeve vacuum conduit as earlier-described at 508 in FIG. 3; chilled water out as described in FIG. 3 and conduit 484; chilled water in as described in FIG. 3 at conduit 480; an air sensor arrangement providing air pressure information from access region 140; heater inputs and outputs; and thermocouple leads. For access convenience, the electrical circuitry is directed from the die entrance 122 and out of the die exit 190 and then is returned to functional connection.

Since certain changes may be made in the above-described apparatus without departing from the scope of the invention herein involved, it is intended that all matter contained in the description thereof or shown in the accompanying drawings shall be interpreted as illustrative and not in a limiting sense.

1. Die apparatus having an axis and extending between a die entrance and a die exit, and configured to form corrugated pipe from thermoplastic material in association with transported wall mold sets, defining a wall forming tunnel comprising:
an outer wall forming treatment assembly including an outer wall homogenizing assembly configured to receive a said material and having an annular outer wall homogenizing exit through which said material is expressible;
an annular delivery channel spaced from and extending along said die axis having an outwardly disposed surface, configured in material transfer relationship with said outer wall homogenizer exit and extending a reservoir distance to an annular outer wall nozzle through which said material is expressible into wall profile defining relationship with said mold sets;
an extender conduit having an input configured for receiving a said material under pressure, having a surface extending in spaced relationship from said annular delivery chamber to a feed outlet on the vicinity of said outer wall annular nozzle and disposed generally about said axis;
an outer wall forming treatment assembly including an inner wall homogenizer assembly configured to receive a said material from said extender conduit feed outlet and having an annular inner wall homogenizer exit through which said material is expressible and in material transfer relationship with an annular inner wall nozzle located axially downstream from said outer wall annular nozzle through which said material is expressible to engage an inner surface of inwardly depending valleys of the outer wall material formed within said forming tunnel defining mold sets.

2. The die apparatus of claim 1 in which:
said outer wall homogenizer assembly includes an outer wall cutting assembly having an input assembly for receiving said material and spaced radially disposed outer wall distribution paths of given radial pattern having outer wall path outlets, and an outer wall spiral channel assembly having inputs in material flow relationship with said outer wall path outlets and extending to define said outer wall homogenizer exit;
said inner wall homogenizer assembly is located axially downstream from said outer wall homogenizer assembly to define a generally enclosed space with said annular delivery channel and includes an inner wall cutting assembly having an input assembly coupled in material transfer relationship with said extender conduit feed outlet and having spaced radially disposed inner wall distribution paths one or more of which is radially aligned with one or more of said outer wall distribution paths to define axially aligned outer wall and inner wall communication regions, said inner wall distribution paths extending to inner wall path outlets, and an inner wall spiral channel assembly having inputs in material flow relationship with said inner wall path outlets and extending to define said inner wall homogenizer exit.

3. The die apparatus of claim 2 in which:
one or more mutually axially aligned said outer wall and inner wall communication regions are respectively configured with mutually axially aligned outer wall and inner wall communication ports.

4. The die apparatus of claim 3 further comprising:
one or more communications conduits extending between said outer wall and said inner wall communication ports.

5. The die apparatus of claim 4 in which:
one or more said communications conduits extend between said die entrance and said die exit.

6. The die apparatus of claim 2 in which:
the generally annular shaped region between said outer wall nozzle and said inner wall nozzle is configured with one or more access ports communicable with said generally enclosed space.

7. Die apparatus having an axis and extending between a die entrance and a die exit and configured for forming corrugated pipe from thermoplastic material in association with transported wall mold sets defining a wall forming tunnel, comprising:
an outer wall forming treatment assembly adjacent said die entrance including a first homogenizer assembly having a first input configured to receive a said material under pressure and having an annular outer wall homogenizer exit disposed about said axis through which a said material is expressible;
a first delivery channel spaced from and extending along said axis, having an outwardly disposed surface, configured in material transfer relationship with said outer wall homogenizer exit and extending to an annular radially outwardly disposed first and second die lip defining outer wall nozzle through which said material is expressible into wall profile defining relationship with said mold sets;
an extender conduit having an input adjacent said die entrance configured for receiving a said material under pressure, having an extender surface, extending generally within and spaced from said first delivery chamber to a feed outlet;
an inner wall forming treatment assembly including a second homogenizer assembly configured to receive a said material from said feed outlet and having an annular inner wall homogenizer exit disposed about said axis through which said material is expressible;
a second delivery channel spaced from and extending along said axis, configured to receive said material from said inner wall homogenizer exit and extending to an annular, radially outwardly disposed third and fourth die lip defining inner wall nozzle through which said material is expressible to engage an inner surface of the outer wall material formed within said wall forming tunnel defining mold sets;
a first heater assembly having one or more heater components in thermal transfer relationship with said first delivery chamber outwardly disposed surface; and
a second heater assembly having one or more heater components in thermal transfer relationship with said extender conduit extender surface.

8. The die apparatus of claim 7 in which:
said inner wall forming treatment assembly is axially spaced downstream from said outer wall forming treatment assembly to define a generally enclosed space with said first delivery channel within which said extender conduit is located, said enclosed space being effective to provide a radiative thermal transfer to said material within said first delivery channel.

9. The die apparatus of claim 8 in which:
said outer wall treatment assembly and said inner wall treatment assembly are configured having a plurality of mutually axially aligned access ports configured to receive and support axially disposed access conduits communicable between said die entrance and said die exit.

10. The die apparatus of claim 7 in which:
said inner wall forming treatment assembly and said second delivery channel are located axially forwardly from said outer wall nozzle to define an access region; and
said inner wall treatment assembly is configured with one or more access ports communicable between said access region and said enclosed space.

11. The die apparatus of claim 10 further comprising:
a generally semi-cylindrically shaped shield removably mounted over the vertically upwardly disposed portion of said access region.

12. The die apparatus of claim 7 in which:
said outer wall treatment assembly is configured to receive a first said material, and said inner wall treatment assembly is configured to receive a second said material; and
said first material having a formulation different than said second material.

13. The die apparatus of claim 7 further comprising:
an input manifold coupled with said outer wall forming treatment assembly, having a first input port configured to receive a said material under pressure from a first extruding source and effect its flow along a first path to said extender conduit input, and having a second input port configured to receive a said material under pressure from a second extruding source and effect its flow along a second path to said first homogenizer first input.

14. The die apparatus of claim 13 in which:
said input manifold second path is disposed outwardly from said first path and is configured as a preliminary material cutting assembly.

15. The die apparatus of claim 10 in which:
said second homogenizer assembly is configured having a radially outwardly disposed surface situate at said access region;
said second heater assembly has one or more said heater components in thermal transfer relationship with said second homogenizer assembly outwardly disposed surface; and
said second heater assembly is configured with electrical leads extending to said one or more heater components at said homogenizer assembly outwardly disposed surface from said enclosed space and through one or more said access ports.

16. The die apparatus of claim 10 in which:
said second delivery chamber third die lip is configured having an outer surface located at said access region;
said second heater assembly has one or more said heater components in thermal transfer relationship with said third die lip outer surface; and
said second heater assembly is configured with electrical leads extending to said one or more heater components at said third die lip outer surface from said enclosed space and through one or more said access ports.

17. The die apparatus of claim 10 in which:
said first delivery channel second die lip is configured having an outer surface located at said access region;
said second heater assembly has one or more said heater components in thermal transfer relationship with said second die lip outer surface; and
said second heater assembly is configured with electrical leads extending to said one or more heater components at said second die lip outer surface from said enclosed space and through one or more said access ports.

18. The die apparatus of claim 7 in which:
said second heater assembly has a plurality of said heater components axially disposed in a sequence along said extender conduit extender surface, and is configured having two or more heater energizing electrical networks, each electrically dedicated to a corresponding unique two or more said heater components disposed along said extender surface.

19. The die apparatus of claim 7 further comprising:
a cylindrically shaped cooling sleeve disposed about said axis, having an outer cooling surface engagable in slidable cooling relationship with material expressed from said inner wall nozzle, supported from an annulus shaped inward support ring having a plurality of spaced apart rearwardly extending abutment tabs each having an abutting surface abuttably engaging a surface of said second delivery chamber inner wall nozzle fourth die lip, said abutment tabs being of number and abutting surface area effective to minimize heat transfer from said inner wall nozzle to said cooling sleeve.

20. The die apparatus of claim 19 further comprising:
a thermally insulative pad configured in correspondence with said abutment tab abutting surface and disposed between said abutting surface and said surface of said second delivery chamber inner wall nozzle fourth die lip.

21. The die apparatus of claim 8 in which:
said extender conduit is supported by a first flange coupled within said enclosed space with said outer wall treatment assembly and by a second flange coupled within said enclosed space with said inner wall treatment assembly; and
said second heater assembly has one or more said heater components in thermal transfer relationship with said first flange and said second flange.

22. Die apparatus having an axis extending between a die entrance and a die exit and configured for forming corrugated pipe from thermoplastic material in association with transported wall mold sets defining a wall forming tunnel, comprising:
a wall forming treatment assembly adjacent said die entrance including a homogenizer assembly with an annular homogenizer exit disposed about said axis through which a said material is expressible;
a delivery channel spaced from and extending along said axis, configured with outer and inner walls spaced apart a radial distance to define a channel of annular cross section, said chamber having an entrance in material flow communication with said homogenizer exit and extending to a radially outwardly disposed extrusion nozzle configured with a first die lip extending from said outer wall to an annular first lip edge and a forwardly disposed second die lip extending from said inner wall to an annular second lip edge spaced a lip distance from said first lip edge to define an annular lip opening through which said material may be expressed; and
a control ring having an annulus shape mounted normally to said axis through a said delivery channel wall, having a radially disposed annular edge region extensible within said defined channel and radially adjustable with respect to said axis to alter said channel annular cross section an amount effective to provide a substantially uniform flow of said material about said delivery chamber into said extrusion nozzle.

23. The die apparatus of claim 22 further comprising:
a ring-shaped support member extending about said control ring and incorporating radially disposed screw members having tips extending therethrough to freely abutting contact with a radially disposed surface of said control ring and being manipulatable to alter said channel annular cross section.

24. The die apparatus of claim 22 further comprising:
a ring-shaped support member extending over a portion of said first die lip and incorporating radially disposed concentricity screw members having tips extending therethrough to freely abutting contact with said portion of said first die lip and being manipulatable to radially maneuver said first die lip toward concentricity with said second die lip.

25. The die apparatus of claim 22 in which:
said second die lip is supported from said delivery channel inner wall; and
further comprising a ring-shaped wall support member fixed to said delivery channel inner wall and configured with a plurality of radially outwardly disposed spaced apart stand-off components extending within said delivery channel into supportive freely abutting contact with the radially inwardly disposed surface of said delivery channel outer wall.

26. The die apparatus of claim 22 further comprising:
an inner wall delivery channel spaced from and extending along said axis downstream from said extrusion nozzle second die lip, configured with liner outer and inner walls spaced apart a radial distance to define a liner channel of annular cross section, said channel carrying a said material under pressure and extending to a radially outwardly disposed liner extrusion nozzle configured with a third die lip extending from said liner outer wall to an annular third lip edge and a forwardly disposed fourth die lip extending from said liner inner wall to an annular fourth lip edge.
a liner control ring having an annulus shape mounted normally to said axis through a said liner wall having a radially disposed annular edge region extensible within said defined liner chamber and radially adjustable with respect to said axis to alter said liner channel cross section an amount effective to provide a substantially uniform flow of said material about said liner chamber into said liner extrusion nozzle.

27. The die apparatus of claim 26 further comprising:
a ring-shaped liner support member extending about said liner control ring and incorporating radially disposed screw members having tips extending therethrough to freely abutting contact with a radially disposed surface of said liner control ring and being manipulatable to alter said liner channel cross section.

28. The die apparatus of claim 26 further comprising:
a ring-shaped liner support member extending over a portion of said third die lip and incorporating radially disposed concentricity screw members having tips extending therethrough to freely abutting contact with said portion of said third die lip and being manipulatable to radially maneuver said third die lip toward concentricity with said fourth die lip.
